(19) United States
(12) Patent Application Publication
(10) Pub. No.: US 2010/0309109 A1
(43) Pub. Date: Dec. 9, 2010

(54) LOCAL DIMMING METHOD AND DISPLAY APPARATUS USING THE SAME

(75) Inventor: Kang-young Won, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/794,140

(22) Filed: Jun. 4, 2010

(30) Foreign Application Priority Data
Jun. 8, 2009 (KR) 10-2009-0050557
May 18, 2010 (KR) 10-2010-0046464

(51) Int. Cl. G09G 3/36

(52) U.S. Cl. 345/102

(57) ABSTRACT

A local dimming method and a display apparatus applying the local dimming method are provided. The display apparatus includes light source groups arranged in an edge thereof, and adjusts light output of the light source groups which irradiate light based on a luminance of an area of a video to be displayed. Therefore, the local dimming method may be applied to an edge-type display apparatus, and accordingly it may be possible to reduce power consumption in the edge-type display apparatus and increase the contrast ratio, thereby providing a user with a high quality video.

### CROSS-REFERENCE TO RELATED APPLICATIONS

This application claims priority from Korean Patent Application No. 10-2009-0050557, filed on Jun. 8, 2009, and Korean Patent Application No. 10-2010-0046464, filed on May 18, 2010, in the Korean Intellectual Property Office, the disclosure of which is incorporated herein by reference in its entirety.

### BACKGROUND OF THE INVENTION

1. Field of the Invention

Apparatuses and methods consistent with the present invention relate to a local dimming method and a display apparatus applying the same, and more particularly, to a local dimming method which reduces power consumption in a display apparatus and increases a contrast ratio, and to a display apparatus applying the same.

2. Description of the Related Art

Light-emitting diodes (LEDs) are widely used as backlights of liquid crystal display televisions (LCD TVs) in various fields because of their excellent performance and long durability.

LCD TVs employing direct-type LED backlights have been commonly used, but recently, edge-type LED backlights are being introduced to be employed in LCD TVs.

Since LCD TVs with edge-type LED backlights are thin, consumers provide good feedback. However, such related art LCD TVs with edge-type LED backlights are not able to irradiate light onto a predetermined area only, and thus it is impossible to implement local dimming.

In other words, related art LCD TVs with edge-type LED backlights are able to perform only global dimming on the entire screen.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

An aspect of the present invention provide a local dimming method, which is applicable to an edge-type display apparatus in order to reduce power consumption in the edge-type display apparatus and increase a contrast ratio, thereby providing a user with a high quality video.

An exemplary embodiment of the present invention provides a display apparatus may include: a display on which a video is displayed; a backlight unit (BLU) including a plurality of light source groups disposed on an edge of the display apparatus; and a controller which controls the BLU so that light output from light source groups which irradiate an area of the video is adjusted based on a luminance of the area.

According to an exemplary embodiment of the present invention, the controller may control the BLU so that the light output from each of the light source groups which irradiate the area is adjusted individually based on the luminance of the area.

According to an exemplary embodiment of the present invention, the video may include a plurality of areas arranged in rows, wherein if at least one area disposed in a predetermined row is a high luminance area, the controller controls the BLU so that at least one light source group which irradiates the at least one area in the predetermined row continues to output a first high-intensity light.

According to an exemplary embodiment of the present invention, the video may include a plurality of areas arranged in columns, wherein if at least one area disposed in a predetermined column is a high luminance area, the controller controls the BLU so that at least one light source group which irradiates the at least one area in the predetermined column continues to output a first high-intensity light.

According to an exemplary embodiment of the present invention, the controller may control the BLU so that a light source group adjacent to the high luminance area continues to output a second high-intensity light.

According to an exemplary embodiment of the present invention, the controller may control the BLU so that a light source group adjacent to the high luminance area continues to output a second high-intensity light.

According to an exemplary embodiment of the present invention, the apparatus may further include: a video processor which performs video processing so that low luminance areas disposed in the predetermined row are lowered in luminance.

According to an exemplary embodiment of the present invention, the video processor may perform video processing so that a luminance of a low luminance area separated from the high luminance area becomes lower than a luminance of a low luminance area adjacent to the high luminance area.

According to an exemplary embodiment of the present invention, the apparatus may further include: a video processor which performs video processing so that low luminance areas disposed in the predetermined column are lowered in luminance.

According to an exemplary embodiment of the present invention, the video processor may perform video processing so that a luminance of a low luminance area separated from the high luminance area becomes lower than a luminance of a low luminance area adjacent to the high luminance area.

According to an exemplary embodiment of the present invention, the video may include a plurality of areas arranged in rows, wherein if areas disposed in a predetermined row are low luminance areas, the controller controls the BLU so that light source groups which irradiate the areas in the predetermined row continue to output a low-intensity light.

According to an exemplary embodiment of the present invention, the video may include a plurality of areas arranged in columns, wherein if areas disposed in a predetermined column are low luminance areas, the controller controls the BLU so that light source groups which irradiate the areas in the predetermined column continue to output a low-intensity light.

According to an exemplary embodiment of the present invention, the apparatus may further include: a video processor which, if luminance distortion occurs in the area due to an adjustment of the light output from the light source groups, adjusts the luminance of the area, and which outputs an adjusted video, in which the luminance of the area is adjusted, to the display.

According to an exemplary embodiment of the present invention, the method may include: determining a luminance of an area of a video to be displayed on the display apparatus; and adjusting light output from light source groups, which are disposed on an edge of the display apparatus and which irradiate the area, based on the determined luminance of the area.

According to an exemplary embodiment of the present invention, the adjusting may include individually adjusting light output from each of the light source groups which irradiate the area based on the luminance of the area.

According to an exemplary embodiment of the present invention, the video may include a plurality of areas arranged in rows, wherein the adjusting includes: if at least one area disposed in a predetermined row is a high luminance area, controlling at least one light source group which irradiates the at least one area in the predetermined row to continue to output a first high-intensity light.

According to an exemplary embodiment of the present invention, the adjusting may further include: controlling a light source group adjacent to the high luminance area to continue to output a second high-intensity light.

According to an exemplary embodiment of the present invention, the method may further include: performing video processing so that low luminance areas disposed in the predetermined row are lowered in luminance.

According to an exemplary embodiment of the present invention, the performing may include: performing video processing so that a luminance of a low luminance area separated from the high luminance area becomes lower than a luminance of a low luminance area adjacent to the high luminance area.

According to an exemplary embodiment of the present invention, the video may include a plurality of areas arranged in columns, wherein the adjusting may include: if at least one area disposed in a predetermined column is a high luminance area, controlling the at least one of the light source groups which irradiate the areas in the predetermined column to continue to output a first high-intensity light.

According to an exemplary embodiment of the present invention, the adjusting may further include: controlling a light source group adjacent to the high luminance area among the light source groups which irradiate the areas in the predetermined column to continue to output a second high-intensity light.

According to an exemplary embodiment of the present invention, the method may further include: performing video processing so that low luminance areas in the predetermined column are lowered in luminance.

According to an exemplary embodiment of the present invention, the performing may include performing video processing so that a luminance of a low luminance area separated from the high luminance area becomes lower than a luminance of a low luminance area adjacent to the high luminance area.

According to an exemplary embodiment of the present invention, the video may include a plurality of areas arranged in rows, wherein the adjusting may include: if all the areas disposed in a predetermined row are low luminance areas, controlling light source groups which irradiate the areas in the predetermined row to continue to output a low-intensity light.

According to an exemplary embodiment of the present invention, the video may include a plurality of areas arranged in columns, wherein the adjusting may include: if all the areas disposed in a predetermined column are low luminance areas, controlling light source groups which irradiate the areas in the predetermined column to continue to output a low-intensity light.

According to an exemplary embodiment of the present invention, the method may further include: if luminance distortion occurs in the area due to adjustment of light output from the light source groups, performing video processing on the area to adjust the luminance of the area.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a block diagram illustrating a liquid crystal display television (LCD TV) according to an exemplary embodiment of the present invention;

FIG. 2 is a view illustrating a structure of a backlight unit (BLU) according to an exemplary embodiment of the present invention;

FIG. 3 is a view explaining light emitting diode (LED) groups and division of a broadcast screen according to an exemplary embodiment of the present invention;

FIG. 4 is a view schematizing a local dimming method according to an exemplary embodiment of the present invention;

FIG. 5 is a flowchart explaining a local dimming method according to an exemplary embodiment of the present invention;

FIG. 6 is a flowchart explaining a local dimming method according to another exemplary embodiment of the present invention; and

FIG. 7 is a flowchart explaining a local dimming method according to still another exemplary embodiment of the present invention.

### DETAILED DESCRIPTION OF EXEMPLARY EMBODIMENTS

Certain exemplary embodiments of the present invention will now be described in greater detail with reference to the accompanying drawings.

In the following description, the same drawing reference numerals are used for the same elements even in different drawings. The matters defined in the description, such as detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

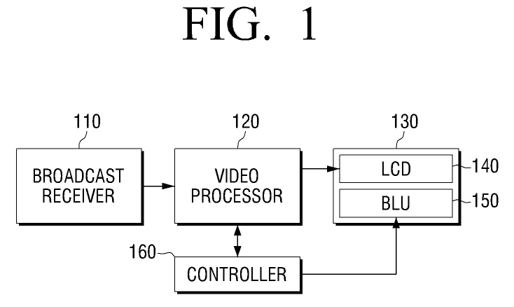

FIG. 1 is a block diagram of a liquid crystal display television (LCD TV) according to an exemplary embodiment of the present invention. The LCD TV shown in FIG. 1 employs an edge-type light emitting diode (LED) backlight, and provides backlights to an LCD using a plurality of LEDs arranged on an edge thereof.

As shown in FIG. 1, the LCD TV includes a broadcast receiver 110, a video processor 120, an LCD module 130 and a controller 160.

The broadcast receiver 110 receives broadcast content from a broadcast station, a satellite or an external input device, via wire or wirelessly, and demodulates the received broadcast content.

The video processor 120 performs signal processing, such as video decoding, video scaling, frame rate conversion (FRC), luminance adjustment, color control, with respect to the broadcast content output from the broadcast receiver 110.

The LCD module 130 includes an LCD 140 and a backlight unit (BLU) 150. The LCD 140 displays the broadcast content processed by the video processor 130.

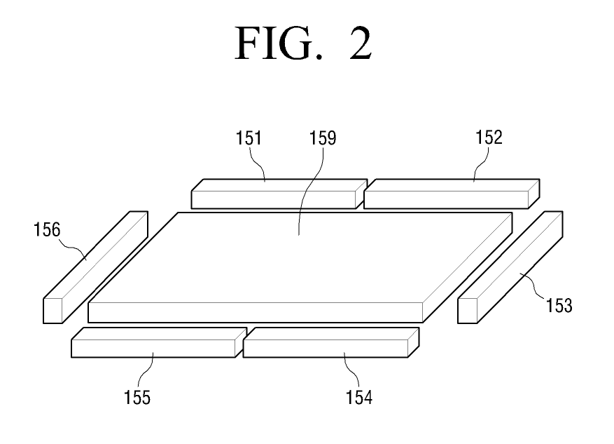

The BLU 150 projects a backlight onto the LCD 140, because the LCD 140 is not able to emit light by itself. Since the LCD TV of FIG. 1 employs an edge-type LED backlight as described above, the BLU 150 is also an edge-type LED backlight. Hereinafter, the structure of the BLU 150 is described in detail with reference to FIG. 2.

FIG. 2 illustrates the structure of the BLU 150, an example of which is shown in FIG. 1. In FIG. 2, the BLU 150 includes six LED strings 151, 152, 153, 154, 155 and 156.

Referring to FIG. 2, 1) a first LED string 151 and second LED string 152 are disposed on a top portion of a light guide plate (LGP) 159 and the LCD 140 (not shown in FIG. 2), 2) a third LED string 153 is disposed on a right side of the LGP 159 and the LCD 140, 3) a fourth LED string 154 and fifth LED string 155 are disposed on a bottom portion of the LGP 159 and the LCD 140, and 4) a sixth LED string 156 is disposed on a left side of the LGP 159 and the LCD 140.

In other words, the first to sixth LED strings 151 to 156 enclose an edge of the LGP 159 below the LCD 140 (not shown in FIG. 2), and accordingly may be disposed on the edge of the LCD TV. In this way, the LED strings 151 to 156 may be disposed at edges of the LCD TV. The LED strings 151 to 156 do not need to be directly contacting the LGP 159. Instead, as shown in FIG. 2, LED strings 151 to 156 can be offset from the LGP 159.

Additionally, the first to sixth LED strings 151 to 156 are divided into a plurality of LED groups. It should be noted that although FIG. 2 shows first through sixth LED strings 151 to 156, this is merely one exemplary embodiment. One of skill in the art would readily understand that the present invention could be applied to a design having a single LED string, as well as designs having a plurality of LED strings.

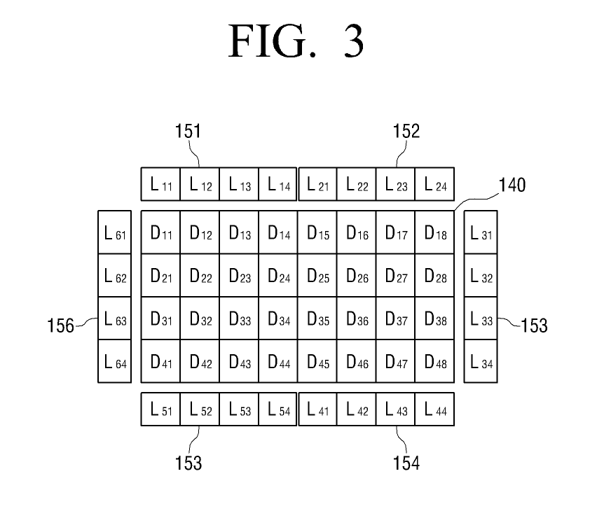

Hereinafter, a situation in which each of the first to sixth LED strings 151 to 156 is divided into four LED groups is described with reference to FIG. 3. In FIG. 3, 1) the first LED string 151 is divided into four LED groups L₁₁, L₁₂, L₁₃, L₁₄, 2) the second LED string 152 is divided into four LED groups L₂₁, L₂₂, L₂₃, L₂₄, . . . , and 6) the sixth LED string 156 is divided into four LED groups L₆₁, L₆₂, L₆₃, L₆₄.

The number of LEDs disposed in a single LED string is the same, and the number of LED groups into which a single LED string is divided is the same. Additionally, the number of LEDs in a single LED group is also the same. For example, if the number of LEDs disposed in a single LED string is 40, each of four LED groups of the LED string includes ten LEDs.

FIG. 3 illustrates a broadcast screen to be displayed on the LCD 140 which is enclosed by the first to sixth LED strings 151 to 156. The broadcast screen is divided into 32 areas (4 rows and 8 columns).

The number of rows and columns of the broadcast screen is associated with the number of LED groups. In more detail, since four LED groups are vertically disposed, the broadcast screen is divided into 4 rows. Additionally, since eight LED groups are horizontally disposed, the broadcast screen is divided into 8 columns.

In FIG. 3, 1) the LED groups L₁₁ and L₅₁ irradiate light onto areas D₁₁, D₂₁, D₃₁, D₄₁ in the first column, 2) the LED groups L₁₂ and L₅₂ irradiate light onto areas D₁₂, D₂₂, D₃₂, D₄₂ in the second column, . . . , and 8) the LED groups L₂₄ and L₄₄ irradiate light onto areas D₁₈, D₂₈, D₃₈, D₄₈ in the eighth column.

More exactly, LED groups irradiate light onto the LGP 159 (see FIG. 2) disposed below the LCD 140, not onto the areas of the broadcast screen displayed on the LCD 140. However, for convenience of description, it is assumed in the exemplary embodiment of the present invention that LED groups irradiate light onto the areas of the broadcast screen displayed on the LCD 140.

Additionally, 1) the LED groups L₆₁ and L₃₁ irradiate light onto areas D₁₁, D₁₂, D₁₃, D₁₄, D₁₅, D₁₆, D₁₇, D₁₈ in the first row, 2) the LED groups L₆₂ and L₃₂ irradiate light onto areas D₂₁, D₂₂, D₂₃, D₂₄, D₂₅, D₂₆, D₂₇, D₂₈ in the second row, 3) the LED groups L₆₃ and L₃₃ irradiate light onto areas D₃₁, D₃₂, D₃₃, D₃₄, D₃₅, D₃₆, D₃₇, D₃₈ in the third row, and 4) the LED groups L₆₄ and L₃₄ irradiate light onto areas D₄₁, D₄₂, D₄₃, D₄₄, D₄₅, D₄₆, D₄₇, D₄₈ in the fourth row.

Accordingly, the LED groups may irradiate light onto a predetermined row or a predetermined column, because the LGP 159 ensures directivity of light irradiated by the LED groups.

The BLU 150 has been described in detail with reference to FIGS. 2 and 3. Hereinafter, the controller 160 is described in detail with reference to FIG. 1.

The controller 160 controls the BLU 150 and the video processor 120 in order to achieve local dimming.

In more detail, the controller 160 controls the BLU 150 so that light output of LED groups is adjusted based on luminance of the plurality of areas which form the broadcast screen to be displayed on the LCD 140.

Owing to such adjustment of light output of LED groups, luminance distortion may occur in some areas of the broadcast screen. In order to compensate for the luminance distortion, the controller 160 may control the video processing operation of the video processor 120.

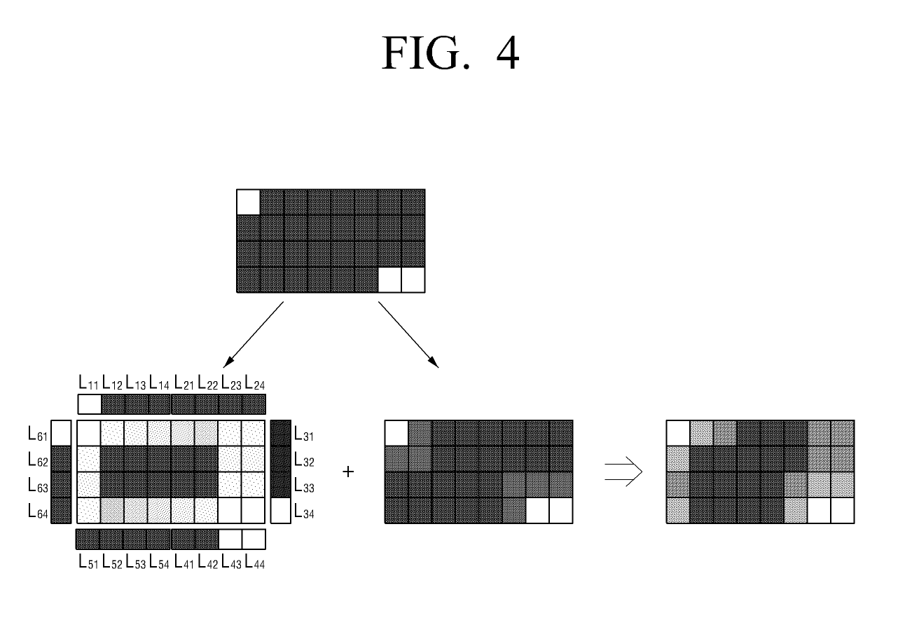

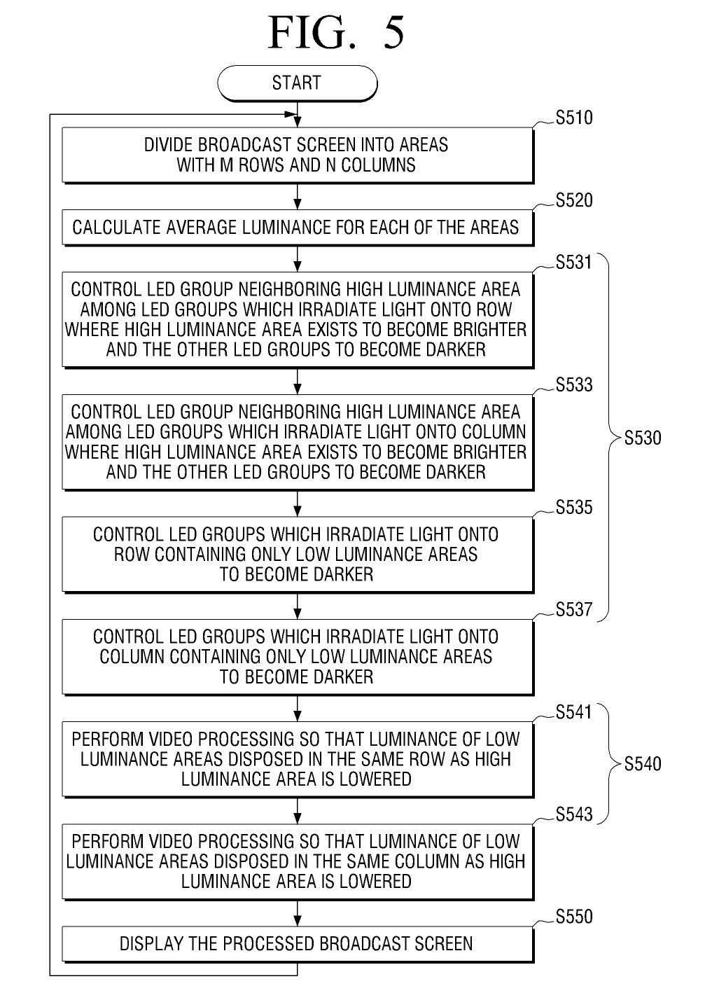

FIG. 4 schematizes a local dimming method, and FIG. 5 is a flowchart explaining the local dimming method.

Hereinafter, a process by which the LCD TV of FIG. 1 performs local dimming is described in detail with reference to FIGS. 4 and 5.

In FIG. 5, the video processor 120 divides the broadcast screen received from the broadcast receiver 110 into a plurality of areas with M rows and N columns (S510). In the exemplary embodiment of the present invention, the broadcast screen is divided into 32 areas with 4 rows and 8 columns.

The video processor 120 calculates an average luminance for each of the areas into which the broadcast screen is divided in operation S510 (S520). The average luminance calculated in operation S520 is transmitted to the controller 160.

The controller 160 controls the BLU 150 to adjust light output of LED groups based on the average luminance calculated in operation S520 (S530).

In more detail, the controller 160 controls the BLU 150 so that an LED group neighboring a high luminance area among LED groups which irradiate light onto a ‘row’ where the ‘high luminance area’ exists becomes brighter and so that the other LED groups become darker (S531).

Herein, an average luminance of the high luminance area is equal to or greater than a first luminance, and an average luminance of the low luminance area is equal to or less than a second luminance. The first luminance is greater than the second luminance, and the first luminance and second luminance may be set as required.

A broadcast screen is exemplarily shown in a top line of FIG. 4. Areas D₁₁, D₄₇ and D₄₈ of the broadcast screen are high luminance areas, and the other areas are low luminance areas.

Referring to FIGS. 3 and 4, the LED groups L₆₁ and L₃₁ irradiate light onto the first row where the high luminance area D₁₁ exists. In operation S531, the controller 160 controls the BLU 150 so that the LED group L₆₁ adjacent to the high luminance area D₁₁ becomes brighter and the LED group L₃₁ separated from the high luminance area D₁₁ becomes darker.

Additionally, the LED groups L₆₄ and L₃₄ irradiate light onto the fourth row in which high luminance areas D₄₇ and D₄₈ exist. In operation S531, the controller 160 controls the BLU 150 so that the LED group L₃₄ adjacent to the high luminance areas D₄₇ and D₄₈ becomes brighter and the LED group L₆₄ separated from the high luminance areas D₄₇ and D₄₈ becomes darker.

A result obtained by operation S531 is shown in a left lower part of FIG. 4. The result indicates that the LED groups L₆₁ and L₃₄ brightly shown in FIG. 4 are being brightened, and the LED groups L₃₁ and L₆₄ dimly shown in FIG. 4 are being darkened.

Additionally, the controller 160 controls the BLU 150 so that an LED group neighboring a high luminance area among LED groups which irradiate light onto a ‘column’ where the ‘high luminance area’ exists becomes brighter and so that the other LED groups become darker (S533).

Referring to FIGS. 3 and 4, the LED groups L₁₁ and L₅₁ irradiate light onto the first column in which the high luminance area D₁₁ exists. In operation S533, the controller 160 controls the BLU 150 so that the LED group L₁₁ adjacent to the high luminance area D₁₁ becomes brighter and the LED group L₅₁ separated from the high luminance area D₁₁ becomes darker.

The LED groups L₂₃ and L₄₃ irradiate light onto the seventh column in which the high luminance area D₄₇ exists. In operation S533, the controller 160 controls the BLU 150 so that the LED group L₄₃ adjacent to the high luminance area D₄₇ becomes brighter and the LED group L₂₃ separated from the high luminance area D₄₇ becomes darker.

Moreover, the LED groups L₂₄ and L₄₄ irradiate light onto the eighth column in which the high luminance area D₄₈ exists. In operation S533, the controller 160 controls the BLU 150 so that the LED group L₄₄ adjacent to the high luminance area D₄₈ becomes brighter and the LED group L₂₄ separated from the high luminance area D₄₈ becomes darker.

A result obtained by operation S533 is also shown in the left lower part of FIG. 4. The result indicates that the LED groups L₁₁, L₄₃ and L₄₄ brightly shown in FIG. 4 are being brightened, and the LED groups L₅₁, L₂₃ and L₂₄ dimly shown in FIG. 4 are being darkened.

The controller 160 controls the BLU 150 so that LED groups which irradiate light onto a ‘row’ containing ‘only low luminance areas’ become darker (S535).

As shown in the top line of FIG. 4, a second row and third row contain low luminance areas only.

The LED groups L₆₂ and L₃₂ irradiate light onto the second row, and the LED groups L₆₃ and L₃₃ irradiate light onto the third row.

In operation S535, the controller 160 controls the BLU 150 so that the LED groups L₆₂, L₃₂, L₆₃ and L₃₃ become darker.

A result obtained by operation S535 is also shown in the left lower part of FIG. 4. In other words, the LED groups L₆₂, L₃₂, L₆₃ and L₃₃ are shown dimly in FIG. 4.

Additionally, the controller 160 controls the BLU 150 so that LED groups which irradiate light onto a ‘column’ containing ‘only low luminance areas’ become darker (S537).

As shown in FIG. 4, a second column, a third column, a fourth column, a fifth column and a sixth column contain low luminance areas only.

1) The LED groups L₁₂ and L₅₂ irradiate light onto the second column, 2) the LED groups L₁₃ and L₅₃ irradiate light onto the third column, 3) the LED groups L₁₄ and L₅₄ irradiate light onto the fourth column, 4) the LED groups L₂₁ and L₄₁ irradiate light onto the fifth column, and 5) the LED groups L₂₂ and L₄₂ irradiate light onto the sixth column.

In operation 5537, the controller 160 controls the BLU 150 so that the LED groups L₁₂, L₅₂, L₁₃, L₅₃, L₁₄, L₅₄, L₂₁, L₄₁, L₂₂ and L₄₂ become darker.

A result obtained by operation S537 is also shown in the left lower part of FIG. 4. In other words, the LED groups L₁₂, L₅₂, L₁₃, L₅₃, L₁₄, L₅₄, L₂₁, L₄₁, L₂₂ and L₄₂ are shown dimly in FIG. 4.

After operations S531 through S537, luminance distortion may occur in some areas of the broadcast screen. This is because a user feels as if these areas have high luminance since the brightened LED groups enable backlights to be brightened even in low luminance areas.

As shown in the left lower part of FIG. 4, 1) backlights are brightened in dark areas D₁₂, D₁₃, D₁₄, D₁₅, D₁₆, D₁₇, D₁₈ onto which the brightened LED group L₆₁ irradiates light, and thus a user may feel as if luminance of these dark areas is greater than the original luminance; 2) backlights are brightened in dark areas D₄₁, D₄₂, D₄₃, D₄₄, D₄₅, D₄₆ onto which the brightened LED group L₃₄ irradiates light, and thus a user may feel as if luminance of these dark areas is greater than the original luminance; 3) backlights are brightened in dark areas D₂₁, D₃₁, D₄₁ onto which the brightened LED group L₁₁ irradiates light, and thus a user may feel as if luminance of these dark areas is greater than the original luminance; 4) backlights are brightened in dark areas D₁₇, D₂₇, D₃₇ onto which the brightened LED group L₄₃ irradiates light, and thus a user may feel as if luminance of these dark areas is greater than the original luminance; and 5) backlights are brightened in dark areas D₁₈, D₂₈, D₃₈ onto which the brightened LED group L₄₄ irradiates light, and thus a user may feel as if luminance of these dark areas is greater than the original luminance.

In order to compensate for such luminance distortion occurring due to operations S531 through S537, the controller 160 controls the video processing operation of the video processor 120 (S540).

In more detail, the controller 160 controls the video processor 120 to perform video processing so that luminance of low luminance areas disposed in the same ‘row’ as a high luminance area is lowered (S541).

For example, the controller 160 may control the video processor 120 to perform video processing so that luminance of low luminance areas D₁₂, D₁₃, D₁₄, D₁₅, D₁₆, D₁₇, D₁₈ disposed in the same ‘row’ as the high luminance area D₁₁ may be lowered. Therefore, it is possible to compensate for luminance distortion occurring in D₁₂, D₁₃, D₁₄, D₁₅, D₁₆, D₁₇, D₁₈ due to the brightened LED group L₆₁.

Furthermore, the controller 160 may control the video processor 120 to perform video processing so that luminance of low luminance areas D₄₁, D₄₂, D₄₃, D₄₄, D₄₅, D₄₆ disposed in the same ‘row’ as the high luminance areas D₄₇ and D₄₈ may be lowered. Therefore, it is possible to compensate for luminance distortion occurring in D₄₁, D₄₂, D₄₃, D₄₄, D₄₅, D₄₆ due to the brightened LED group L₃₄.

After operation S541, the controller 160 controls the video processor 120 to perform video processing so that luminance of low luminance areas disposed in the same ‘column’ as a high luminance area is lowered (S543).

For example, the controller 160 may control the video processor 120 to perform video processing so that luminance of low luminance areas D₂₁, D₃₁, D₄₁ disposed in the same column as the high luminance area D₁₁ may be lowered. Therefore, it is possible to compensate for luminance distortion occurring in D₂₁, D₃₁, D₄₁ due to the brightened LED group L₁₁.

Moreover, the controller 160 may control the video processor 120 to perform video processing so that luminance of low luminance areas D₁₇, D₂₇, D₃₇ disposed in the same column as the high luminance area D₄₇ may be lowered. Therefore, it is possible to compensate for luminance distortion occurring in D₁₇, D₂₇, D₃₇ due to the brightened LED group L₄₃.

In addition, the controller 160 may control the video processor 120 to perform video processing so that luminance of low luminance areas D₁₈, D₂₈, D₃₈ disposed in the same column as the high luminance area D₄₈ may be lowered. Therefore, it is possible to compensate for luminance distortion occurring in D₁₈, D₂₈, D₃₈ due to the brightened LED group L₄₄.

FIG. 4 conceptually illustrates the video processing operation. A compensation screen shown in the center lower part of FIG. 4 may be added to the original broadcast screen, in order to perform video processing so that the dark areas in the original broadcast screen become much darker.

The compensation screen is used to reduce luminance of areas, where luminance distortion may occur, and to compensate for the luminance distortion. Additionally, the compensation screen enables luminance of dark areas, where there is no luminance distortion, to be lowered, in order to enhance luminance contrast.

Subsequently, the LCD module 130 displays the broadcast screen processed by the video processor 120 in operation S540 (S550), as shown in a right lower part of FIG. 4. In more detail, in FIG. 4, the processed broadcast screen in the right lower part may be displayed by combining the compensation screen shown in the center lower part with the original broadcast screen shown in the top layer, and by turning backlights on according to the result in the left lower part.

The process by which the LCD TV with the edge-type LED backlight performs local dimming has been described in detail with reference to the exemplary embodiment of the present invention.

The LCD-TV according to the exemplary embodiment of the present invention is merely an example of a display capable of employing an edge-type LED backlight. Accordingly, the present invention is applicable to a display apparatus employing an edge-type LED backlight other than such a TV, and also applicable to an apparatus capable of displaying videos other than the broadcast screen.

Additionally, the present invention is applicable to a situation in which the LCD is replaced with other types of displays requiring an edge-type LED backlight. Furthermore, the LED may be replaced with other types of light sources.

The number of LED strings and the number of LED groups provided in the exemplary embodiment of the present invention may be changed. Additionally, the number of LEDs provided according to the number of LED strings and the number of LEDs provided according to the number of LED groups may also be changed.

Furthermore, the number of LEDs may be set differently for each LED string, or may be set differently for each LED group.

Moreover, various methods for dividing video may be used other than the method provided in the exemplary embodiment of the present invention.

In the exemplary embodiment of the present invention, only LED groups adjacent to the high luminance area are brightened. However, this is merely an example for convenience of description, and thus can be changed. Accordingly, LED groups which are not adjacent to the high luminance area may also be brightened.

Additionally, the output level of brightened LED groups may vary instead of remaining constant. In this situation, the output level may be set based on the luminance of high luminance areas.

For example, LED groups adjacent to an area with very high luminance may be greatly brightened, and LED groups adjacent to an area with slightly high luminance may be slightly brightened.

Likewise, the output level of darkened LED groups may vary instead of remaining constant, and may be set based on the luminance of high luminance areas.

Moreover, it is possible to change how much brighter or darker the broadcast screen appears during video processing. In this situation, video processing may be performed variously taking into consideration the original luminance of areas in the broadcast screen and the output level of LED groups.

In addition, the compensation screen enables luminance of dark areas, where there is no luminance distortion, to be lowered in the exemplary embodiment of the present invention, but the compensation screen may be omitted if not required.

Furthermore, during video processing, ‘luminance of a low luminance area separated from a high luminance area’ may become lower than ‘luminance of a low luminance area neighboring a high luminance area’. Referring to the compensation screen shown in the center lower part of FIG. 4, signal processing is performed so that the low luminance areas D₁₂, D₂₁, D₂₂, D₃₆, D₃₇, D₃₈, D₄₆ neighboring the high luminance area may get slightly brighter than low luminance areas separated from a high luminance area. In other words, luminance of low luminance areas separated from the high luminance area may be lowered relatively to the low luminance areas D₁₂, D₂₁, D₂₂, D₃₆, D₃₇, D₃₈, D₄₆. However, this operation is also selectively performed, and thus it is possible to perform local dimming even when this operation is not performed.

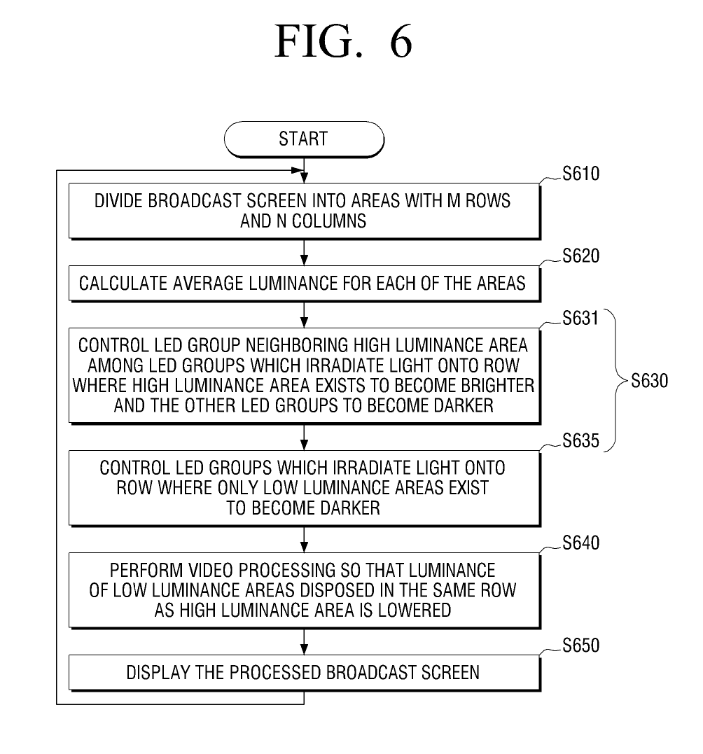

FIG. 6 is a flowchart explaining a local dimming method according to another exemplary embodiment of the present invention.

As shown in FIG. 6, the video processor 120 divides the broadcast screen input from the broadcast receiver 110 in sequence into a plurality of areas with M rows and N columns (S610).

The video processor 120 calculates an average luminance for each of the areas into which the broadcast screen is divided in operation S610 (S620). The average luminance calculated in operation S620 is transmitted to the controller 160.

The controller 160 controls the BLU 150 to adjust light output of LED groups based on the average luminance calculated in operation S620 (S630).

In more detail, the controller 160 controls the BLU 150 so that an LED group neighboring a high luminance area among LED groups which irradiate light onto a ‘row’ where the ‘high luminance area’ exists becomes brighter and so that the other LED groups become darker (S631).

Herein, an average luminance of the high luminance area is equal to or greater than a first luminance, and an average luminance of the low luminance area is equal to or less than a second luminance (second luminance<first luminance). In detail, the first luminance and second luminance may be set as required.

The controller 160 controls the BLU 150 so that LED groups which irradiate light onto a ‘row’ where only ‘low luminance areas’ exist become darker (S635).

Also, in order to compensate for luminance distortion occurring due to operations S631-635, the controller 160 controls the video processor 120 to perform video processing so that luminance of the low luminance areas disposed in the same ‘row’ as the high luminance area is lowered (S640).

After that, the LCD module 130 displays the broadcast screen processed by the video processor 120 in operation S640 (S650),

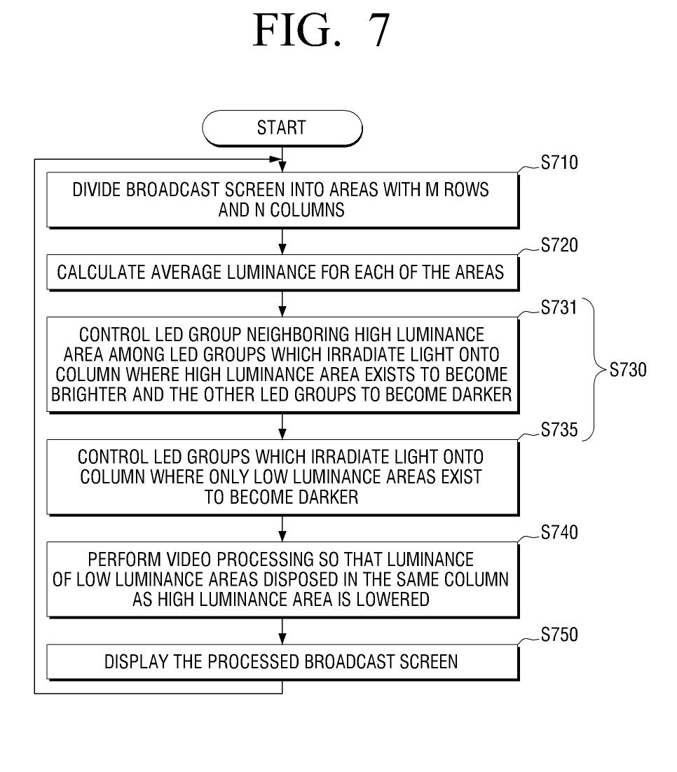

FIG. 7 is a flowchart explaining a local dimming method according to still another exemplary embodiment.

As shown in FIG. 7, the video processor 120 divides the broadcast screen input from the broadcast receiver 110 in sequence into a plurality of areas with M rows and N columns (S710).

The video processor 120 calculates an average luminance for each of the areas into which the broadcast screen is divided in operation S710 (S720). The average luminance calculated in operation S720 is transmitted to the controller 160.

The controller 160 controls the BLU 150 to adjust light output of LED groups based on the average luminance calculated in operation S720 (S730).

In more detail, the controller 160 controls the BLU 150 so that an LED group neighboring a high luminance area among LED groups which irradiate light onto a ‘column’ where the ‘high luminance area’ exists becomes brighter and so that the other LED groups become darker (S731).

Herein, an average luminance of the high luminance area is equal to or greater than a first luminance, and an average luminance of the low luminance area is equal to or less than a second luminance (second luminance<first luminance). In detail, the first luminance and second luminance may be set as required.

The controller 160 controls the BLU 150 so that LED groups which irradiate light onto a ‘column’ where only ‘low luminance areas’ exist become darker (S735).

Also, in order to compensate for luminance distortion occurring due to operations S731-735, the controller 160 controls the video processor 120 to perform video processing so that luminance of the low luminance areas disposed in the same “column” as the high luminance area is lowered (S740).

After that, the LCD module 130 displays the broadcast screen processed by the video processor 120 in operation S740 (S750),

As described above, according to an exemplary embodiment of the present invention, a local dimming method may be applied to an edge-type display apparatus. Therefore, it is possible to reduce power consumption in the edge-type display apparatus and increase the contrast ratio, thereby providing a user with a high quality video.

The foregoing exemplary embodiments are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A display apparatus comprising:
a display on which a video is displayed;
a backlight unit (BLU) comprising a plurality of light source groups disposed on an edge of the display apparatus; and
a controller which controls the BLU so that light output from light source groups which irradiate an area of the video is adjusted based on a luminance of the area.

2. The display apparatus as claimed in claim 1, wherein the controller controls the BLU so that the light output from each of the light source groups which irradiate the area is adjusted individually based on the luminance of the area.

3. The display apparatus as claimed in claim 1, wherein the video comprises a plurality of areas arranged in rows, and
wherein if at least one area disposed in a predetermined row is a high luminance area, the controller controls the BLU so that at least one light source group which irradiates the at least one area in the predetermined row continues to output a first high-intensity light.

4. The display apparatus as claimed in claim 1, wherein the video comprises a plurality of areas arranged in columns, and
wherein if at least one area disposed in a predetermined column is a high luminance area, the controller controls the BLU so that at least one light source group which irradiates the at least one area in the predetermined column continues to output a first high-intensity light.

5. The display apparatus as claimed in claim 3, wherein the controller controls the BLU so that a light source group adjacent to the high luminance area continues to output a second high-intensity light.

6. The display apparatus as claimed in claim 4, wherein the controller controls the BLU so that a light source group adjacent to the high luminance area continues to output a second high-intensity light.

7. The display apparatus as claimed in claim 3, further comprising:
a video processor which performs video processing so that low luminance areas disposed in the predetermined row are lowered in luminance.

8. The display apparatus as claimed in claim 7, wherein the video processor performs video processing so that a luminance of a low luminance area separated from the high luminance area becomes lower than a luminance of a low luminance area adjacent to the high luminance area.

9. The display apparatus as claimed in claim 4, further comprising:
a video processor which performs video processing so that low luminance areas disposed in the predetermined column are lowered in luminance.

10. The display apparatus as claimed in claim 9, wherein the video processor performs video processing so that a luminance of a low luminance area separated from the high luminance area becomes lower than a luminance of a low luminance area adjacent to the high luminance area.

11. The display apparatus as claimed in claim 1, wherein the video comprises a plurality of areas arranged in rows, and
wherein if areas disposed in a predetermined row are low luminance areas, the controller controls the BLU so that light source groups which irradiate the areas in the predetermined row continue to output a low-intensity light.

12. The display apparatus as claimed in claim 1, wherein the video comprises a plurality of areas arranged in columns,
wherein if areas disposed in a predetermined column are low luminance areas, the controller controls the BLU so that light source groups which irradiate the areas in the predetermined column continue to output a low-intensity light.

13. The display apparatus as claimed in claim 1, further comprising:
a video processor which, if luminance distortion occurs in the area due to an adjustment of the light output from the light source groups, adjusts the luminance of the area, and which outputs an adjusted video, in which the luminance of the area is adjusted, to the display.

14. A local dimming method for a display apparatus, the method comprising:
determining a luminance of an area of a video to be displayed on the display apparatus; and
adjusting light output from light source groups, which are disposed on an edge of the display apparatus and which irradiate the area, based on the determined luminance of the area.

15. The method as claimed in claim 14, wherein the adjusting comprises individually adjusting light output from each of the light source groups which irradiate the area based on the luminance of the area.

16. The method as claimed in claim 14, wherein the video comprises a plurality of areas arranged in rows,
wherein the adjusting comprises:
if at least one area disposed in a predetermined row is a high luminance area, controlling at least one light source group which irradiates the at least one area in the predetermined row to continue to output a first high-intensity light.

17. The method as claimed in claim 16, wherein the adjusting further comprises:
controlling a light source group adjacent to the high luminance area to continue to output a second high-intensity light.

18. The method as claimed in claim 16, further comprising:
performing video processing so that low luminance areas disposed in the predetermined row are lowered in luminance.

19. The method as claimed in claim 18, wherein the performing comprises:
performing video processing so that a luminance of a low luminance area separated from the high luminance area becomes lower than a luminance of a low luminance area adjacent to the high luminance area.

20. The method as claimed in claim 14, wherein the video comprises a plurality of areas arranged in columns,
wherein the adjusting comprises:
if at least one area disposed in a predetermined column is a high luminance area, controlling the at least one of the light source groups which irradiate the areas in the predetermined column to continue to output a first high-intensity light.

21. The method as claimed in claim 20, wherein the adjusting further comprises:
controlling a light source group adjacent to the high luminance area among the light source groups which irradiate the areas in the predetermined column to continue to output a second high-intensity light.

22. The method as claimed in claim 20, further comprising:
performing video processing so that low luminance areas in the predetermined column are lowered in luminance.

23. The method as claimed in claim 22, wherein the performing comprises performing video processing so that a luminance of a low luminance area separated from the high luminance area becomes lower than a luminance of a low luminance area adjacent to the high luminance area.

24. The method as claimed in claim 14, wherein the video comprises a plurality of areas arranged in rows,
wherein the adjusting comprises:
if all the areas disposed in a predetermined row are low luminance areas, controlling light source groups which irradiate the areas in the predetermined row to continue to output a low-intensity light.

25. The method as claimed in claim 14, wherein the video comprises a plurality of areas arranged in columns,
wherein the adjusting comprises:
if all the areas disposed in a predetermined column are low luminance areas, controlling light source groups which irradiate the areas in the predetermined column to continue to output a low-intensity light.

26. The method as claimed in claim 14, further comprising:
if luminance distortion occurs in the area due to adjustment of light output from the light source groups, performing video processing on the area to adjust the luminance of the area.
